(19) United States
(12) Patent Application Publication
(10) Pub. No.: US 2025/0346798 A1
(43) Pub. Date: Nov. 13, 2025

(54) METHOD FOR PREVENTING PRODUCTION LOSS DUE TO SALINE SCALING IN OIL PRODUCTION BY INCORPORATING SCALING INHIBITOR INTO THE DRILLING FLUID

(71) Applicant: PETRÓLEO BRASILEIRO S.A. - PETROBRAS, Rio de Janeiro (BR)

(72) Inventors: MARIO GERMINO FERREIRA DA SILVA, Rio de Janeiro (BR); FERNANDO ANTONIO MOREIRA DA SILVA, Rio de Janeiro (BR); VALTAIR MARCOS CRISTANTE, Rio de Janeiro (BR)

(73) Assignee: PETRÓLEO BRASILEIRO S.A. - PETROBRAS, Rio de Janeiro (BR)

(21) Appl. No.: 19/199,740

(22) Filed: May 6, 2025

(30) Foreign Application Priority Data
May 9, 2024 (BR) 1020240092163

(51) Int. Cl. C09K 8/528

(52) U.S. Cl. CPC C09K 8/528

(57) ABSTRACT

The present invention discloses a method for preventing loss of oil production due to scaling of producing wells, through the application of scaling inhibitor in drilling fluids that will be used in the drilling phase of the reservoir rock, and applied in the area of oil reservoirs, aiming to contribute to the guarantee of production flow from the wells, with the presence of scaling inhibitor into the fluid produced by the well, with at least 1 year of effectiveness after opening the well for production.

### CROSS-REFERENCES TO RELATED APPLICATIONS

This application claims the benefit of priority to Brazilian Patent Application No. BR 1020240092163 filed May 9, 2024, the contents of which are hereby incorporated by reference in their entirety for all purposes.

### FIELD OF THE INVENTION

The present invention is applied in the oil industry and discloses a method for preventing the reduction of offshore oil production caused by the formation of scale during the flow of the oil produced from the well to the oil platform, being applied more specifically in wells that suffer from saline scale in the subsea equipment and in the production column.

### DESCRIPTION OF THE STATE OF THE ART

In general, in an oil production project for a producing field, the development of the production of the field depends on the guarantee of the arrival of oil at the surface. This flow guarantee depends on some variables that are normally defined by reservoir engineering in association with lifting and flow engineering.

Among these factors that influence the guarantee of production flow, the formation of saline scale stands out, whose dimensions and location in the production system can create obstructions to oil production, generating losses.

In this way, the inhibition of scale formation or its removal are necessary to guarantee the flow of oil production, as well as for the economic viability of the production development project.

Currently, to solve the problem of the need for reservoir inhibition, aiming to avoid scale formation, only chemical inhibition is used through inhibitor squeeze in reservoirs. However, this operation normally requires the production of the well to be stopped so that the inhibitor squeeze can be injected into the producing formation; then, a period of time is required for the inhibitor to be adsorbed by the reservoir rock. After the adsorption time, when the matrix rock adsorbs part of the scaling inhibitor, the excess is produced when the well is opened for production. This adsorption time is controlled to prevent any damage to the reservoir. During oil production, the inhibitor fluid that was adsorbed by the reservoir rock will begin a chemical desorption process, that is, it will be gradually released with the produced water, thus inhibiting the formation of scale.

The need for chemical reservoir inhibition arises because current well construction projects do not foresee or cannot install chemical injection mandrels in all production intervals. The insertion of the scaling inhibitor in the drilling fluid appears as an alternative to performing well squeezes with high costs inherent to the need to stop well production (with a high value of unproduced oil).

The document US 2017/0233629 lists drilling compositions (drilling mud) comprising aloe vera particles. According to the inventors, the drilling composition may additionally comprise additives, such as an anti-scaling agent, which is incorporated into the drilling composition. Furthermore, the amount of said additive may be up to 10% by weight of the drilling composition, preferably up to 0.5% by weight.

In the document US 2017/0233629, the scaling inhibitor is mentioned as an anti-scaling additive, it does not explicitly state that it is formed from the mixture of incompatible waters such as formation water and/or connate water and injection water, which is seawater. In this case, the mixture of these waters forms saline scales of BaSO₄, SrSO₄ and/or CaCO₃. Apparently, the solution presented by the inventor, when referring to scale, is directed to waste from the hydraulic fracturing process, such as 16×30 or 20×40 mesh sand proppants and/or bauxite. Thus, after the hydraulic fracturing process, there is excess left inside the well, which when it enters production, this waste will be produced and may generate accumulations of this material inside the production column, so an anti-agglomeration product is added to prevent the formation of damage in the column and/or production system, where these solids could agglomerate, generating what the inventor calls scaling, which is different from the approach of the present invention.

The Site Exploration & Drilling—Petronax website (petronaxcorp.com) discloses that scaling inhibitors are chemical products added to the drilling fluid or to the well to prevent the accumulation of mineral deposits, or scaling, in the production piping, and scaling can reduce the flow of oil and gas and increase the cost of production. Regarding said website, it does not mention the type of scaling that may be formed, but it is known that there are several types of scaling, wherein the available literature mentions several types, such as BaSO₄, SRSO₄, CASO₄, (ref.: Deposição Mineral em Superfícies: Problemas e Oportunidades na Indústria do petróleo, “Mineral Deposition on Surfaces: Problems and Opportunities in the Oil Industry”, 2011, Revista Virtual Química). This website also does not mention the type of chemical product that will be used as a scaling inhibitor, nor the concentration in which it will be added to the drilling fluid. It is worth noting that the inhibitor concentration proposed in this patent application is much higher than what is normally found on the market, from 30 to 100 ppm, while the proposal of the present invention can use a concentration of 0.2 to 0.5% (v/v) which is equivalent to 2,000 to 5,000 ppm. In fact, we want the real adsorption and protection of the well by the inhibitor for a period greater than or equal to 1 year.

In view of this, other documents have emerged that explicitly describe the use of scaling inhibitors, but no document from the state of the art discloses a method for applying an inhibitor fluid in drilling fluid operations with the aim of creating a functional filtrate.

In order to solve the lack of a solution, the method of the present invention was developed, through which a scaling inhibitor is added to the drilling fluid formulation and, to which it will be used in drilling the production zones, forming a filtrate with effective scaling inhibitor functionality, without affecting the formation and porosity of the filter cake or causing damage to the reservoir rock, and thus in the future production stage of the well, generating scale inhibition in the production system.

Therefore, it is important to emphasize that the present invention aims to reduce costs, compared to performing squeezes in the production phase of the wells, since it is a method focused on taking advantage of the preparation of drilling fluids, without significantly increasing costs in this phase.

### BRIEF DESCRIPTION OF THE INVENTION

The present invention shows a method for preventing loss of production due to saline scaling in oil production by incorporating a scaling inhibitor into the drilling fluid, through the application of the scaling inhibitor in the drilling fluids that will be used in the drilling phase of the reservoir rock, and implemented in the area of oil reservoirs, aiming to contribute to ensuring the flow of production from the wells, with the presence of scaling inhibitor in the fluid produced by the well.

Another aspect of the invention is that the scaling inhibitor to be used is not a product with a fixed formulation, but rather one that has the best chemical compatibility with the drilling fluid that will be used in the drilling operation of the oil well in the reservoir drilling phase. Thus, there is a scope for all chemical classes of inhibitor products and, depending exclusively on the type of fluid that will be used in drilling the reservoir phase of the oil well, the most suitable product will be selected in terms of chemical compatibility and efficiency.

Thus, the present invention prevents oil production losses by using a scaling inhibitor present in the drilling fluid used in drilling the reservoir phase, incorporated into the production zone, and which, in the event of production, will generate mixtures of produced and injected fluids, inhibited for saline scale and thus avoiding the need for interventions with a stimulation boat or probe, at the beginning of the production development phase to mitigate production loss due to scale, even with bsw around 0.1%.

### BRIEF DESCRIPTION OF THE DRAWINGS

The present invention will be described below with reference to its typical embodiments and with reference to the attached drawings.

FIG. 1 illustrates in a schematic manner the circulation of drilling fluid, according to the state of the art. In FIG. 1, there is a diagram of the circulation of drilling fluid, highlighting the formation of the filter cake (mud cake) in black on the well wall, with the filtrate illustrated in blue, it is possible to verify that the filtrate invades the reservoir rock (formation).

FIG. 2 illustrates the normal filtrate (state of the art) and the filtrate with additives according to the embodiment of the method of the present invention. In this way, the scaling inhibitor, which will be dissolved in the drilling fluid filtrate, will be introduced into the reservoir through the filtration of the drilling fluid, that is, it will be in the filtrate as illustrated in FIG. 2, during the formation of the scale on the well wall.

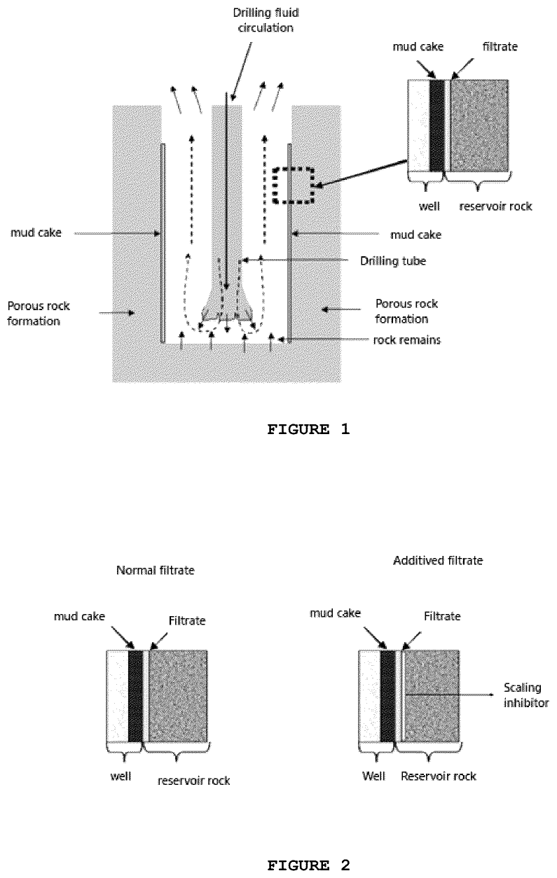

### DETAILED DESCRIPTION OF THE INVENTION

The present invention discloses steps of a method for preventing production loss due to saline scale in oil production by incorporating scaling inhibitor(s) in the fluid used in the drilling stages of a well. The present invention shows that the inhibitor will invade the reservoir together with the drilling fluid filtrate, forming a functional filtrate. According to the present invention, it comprises the following steps.

Definition of the function of the drilling fluid and type of drilling fluid. The fluid should preferably have water as its main component, which can be industrial water or seawater, which is described as water-based fluids. This fluid may or may not contain products that function as agents to combat loss of circulation during well drilling. The drilling fluid is used in the well construction phase, related to the drilling operation itself, during the drilling of the sediment layers of the rock structure comprised of the seabed to the depth of the reservoir rock position. Since the fluids perform several functions during well drilling, the main ones are: a) carrying the cuttings generated in the drill bit, transporting them through the annular space and allowing their separation on the surface; b) cooling and cleaning the drill bit; c) reducing friction between the drilling column and the sides of the well; d) maintaining the stability of the uncased sections of the well; e) preventing the entry of fluids (oil, gas or water) from the permeable rocks penetrated; f) forming a thin, low-permeability coating that seals the pores and other openings in the formations penetrated by the drill; and g) assisting in the collection and interpretation of information available from the cuttings from the drilling, from cores and from the electrical profile. To adequately perform all these functions, according to the lithology of the phase to be drilled, the fluid must contain the correct substances in its composition.

Selection of a scaling inhibitor that must be compatible with the composition of the drilling fluid, i.e., precipitation cannot occur when the scaling inhibitor interacts with the components of the drilling fluid, and the concentration of the scaling inhibitor can be adjusted to ensure the lowest possible consumption of scaling inhibitor product, as well as ensuring the compatibility of the scaling inhibitor with the rock formation for long periods of time (greater than or equal to 1 year). Many fluids with different compositions are used in well drilling. However, in general, these fluids can be grouped according to the diluent used (Water-Based or Non-Aqueous-Based) and according to their main characteristics (Clayey, Polymeric, Saline, among others).

Sizing the volume of scaling inhibitor to be consumed, considering the concentration defined in the previous step. It is worth noting that through detailed laboratory tests, through prior knowledge of the permo-porous characteristics of the reservoir rock and the use of simulators available in the oil industry, it is possible to size the volume of inhibitor that will be necessary.

At the end of the preparation of the drilling fluid, which will be carried out in a tank or mixer on the drilling rig, the addition of the scaling inhibitor will be carried out considering that it is compatible with the reservoir rock.

The drilling fluid is prepared following the order of addition of the products recommended in each fluid project. Using drilling rig fluid preparation tanks, the scaling inhibitor can be added in-line to the circulation system of the rig.

In some cases, the scaling inhibitor content in the filtrate can be monitored through laboratory chemical analysis on the probe, and the mimic concentration of the inhibitor can be replenished if necessary.

Therefore, the solution achieved by the invention is to use the drilling fluid to inject the scaling inhibitor into the reservoir, while still in the reservoir drilling phase, in a concentration range of 0.2 to 0.5% (v/v) of the inhibitor in relation to the total aqueous solution. The production of connate water and aquifer water from reservoirs with temperatures ranging from 70° C. to above 70° C., in carbonate reservoirs mainly in the pre-salt pole, has been observed to form saline scale in up to 70% of the wells currently in operation, due to the fact that despite the low BSW<0.5%, the production of connate water present in the oil zone is already sufficient to cause scale damage in the producing wells due to the formation of scale, as observed in Buzios, Mero and Sépia.

Additionally, the scaling inhibitor is released gradually and only the aqueous phase is capable of releasing the inhibitor adsorbed in the reservoir rock since it is soluble in water through the filling of the porous spaces of the reservoir rock with the filtrate of the inhibited drilling fluid. When the well is put into production, this inhibited fluid positioned inside the reservoir will be produced together with the oil, thus inhibiting the formation of scale, the protection of which will extend from the rock formation to the interior of the production column, and protecting the subsea production system.

This patent application deals with the method for preventing loss of production due to saline scale in oil production by incorporating a scaling inhibitor into the drilling fluid.

In this way, a scaling inhibitor additive can be added to the drilling project fluids that will be used in the operations described, which aims to leave the scaling inhibitor product inside the reservoir, the objective of which is to generate long-lasting protection in terms of inhibiting the formation of scale inside the reservoir, and can reach at least one year of effectiveness after the start of production of the treated well.

The method of the present invention focuses on the preparation 4 g fluid used in the reservoir drilling phase, using pumps suitable for manufacturing fluid and pumping this fluid during drilling and volumetric applications of scale-inhibiting chemicals, with the aim of postponing operations where a stimulation boat connected to the UEP, or probe, is used to achieve an effect similar to the scale-inhibiting squeeze in the reservoir, the latter aiming to protect the entire offshore production system that involves the reservoir, production column, wet Christmas tree, production lines, manifold, production riser and also surface equipment (Top-side), with an effectiveness period of at least one year.

The application of this technology in advance could have prevented the formation of saline scale in wells BUZ-4, BUZ-7 and BUZ-14, among others. If at least 1% of the fluid is stored in the interval, we will probably have the desired effect. If a remote operation is postponed in the year of opening the well, the estimated savings due to oil loss can exceed 8 MM dollars plus the boat that usually costs around 1 MM dollars.

### EXAMPLES

The polyacrylamide-based scaling inhibitor dosed at a concentration of 50 ppm in the seawater-based loss fluid was applied during the drilling phase of the well in the Marlim Leste Field, which was subject to a high volume of seawater-based fluid loss during the drilling phase. The use of a scaling inhibitor added to the seawater was recommended.

Despite the indication of including the scaling inhibitor in drilling or formation loss fluids, in the first stage of adapting this technology, the initial objective is to verify the action of the inhibitor on the fluids injected close to the well, where it would be possible to maintain better control over the concentration of the inhibitor and monitor the behavior of the tracer element (phosphorus).

There are no problems with the compatibility of the inhibitor with the fluid, since the inhibitor is added to the designed saline fluids. There is the possibility of high adsorption of the inhibitor in the rock, but the indicated concentration should be sufficient to maintain a minimum inhibitory concentration. The inhibitor concentration of 100 mg/L is considered sufficient for more severe scale conditions.

Another relevant factor is that the added inhibitor does not affect the rheological properties of the drilling fluid, nor does it affect the viscosity of the fluid.

1. A method for preventing production loss due to saline scaling in oil production by incorporating scaling inhibitor into the drilling fluid, the method characterized by comprising the following steps:
1) defining the function and type of water-based drilling fluid that will be used in drilling the reservoir phases;
2) selecting the scaling inhibitor compatible with the drilling fluid and rock formation, and with adequate efficiency;
3) sizing the volume of scaling inhibitor to be consumed based on the minimum efficient concentration;
4) incorporating the scaling inhibitor into the drilling fluid, which will be absorbed by the producing formation during drilling of the reservoir phase;
5) preparing the drilling fluid following the order of addition of the products recommended in each fluid project using fluid preparation tanks, and the scaling inhibitor can be added from the storage tank itself or injected in line into the circulation system of the rig.

2. The method according to claim 1, wherein the incorporation of the scaling inhibitor into the drilling fluid occurs in a fluid preparation system in the offshore rigs.
